(19) United States
(12) Patent Application Publication
(10) Pub. No.: US 2008/0066465 A1
(43) Pub. Date: Mar. 20, 2008

(54) Turbocharger header for an internal combustion engine

(76) Inventor: Francis Andrew Maidens, Damascus, MD (US)

Correspondence Address: ZITO TLP, P.O. BOX 240, DAMASCUS, MD, 20872, US

(21) Appl. No.: 11/523,599

(22) Filed: Sep. 20, 2006

(51) Int. Cl. F02B 29/04

(52) U.S. Cl. 60/599

(57) ABSTRACT

A header, or manifold, for an exhaust gas turbocharger with a smooth, unobstructed interior and exterior to provide for multiple custom positions of exhaust gas tubes for intake of gas into the header and for multiple custom positions of a turbocharger flange to provide and intake channel into a turbocharger turbine.

### FIELD OF THE INVENTION

The present invention relates to an improved header, or manifold, for a turbocharger used on an engine.

### BACKGROUND OF THE INVENTION

The use of exhaust gas driven turbochargers on internal combustion engines began in 1905 with the invention and patenting of the first turbocharger by Swiss engineer Alfred Buchi. Tests showed that the turbocharger increased power by up to fourty percent. Turbochargers were placed into production for diesel engines on ships and locomotives beginning in the 1920's and were used in production aircraft beginning in the 1930's. Cars and trucks were produced in Europe and the United States with turbo-powered diesel engines starting in 1949 and were introduced in cars in 1952 when Fred Agabashian used a turbocharger to qualify for the pole position at the Indianapolis 500.

There are generally two types of turbochargers. One is the exhaust gas turbocharger that uses the exhaust gas from engine cylinders to drive a turbine. The turbine powers an impeller of vaned rotors which acts as a dynamic compressor to force air into the intake tract of the engine. Spinning at a very high speed, up to 200,000 RPM, the impeller draws in air and forces it under compression into the engine's air intake causing an increase, or boost, of oxygen that enters each cylinder. Specifically, boost is the increase in pressure from gasses in the exhaust header at the intake of the turbine. The increase in oxygen thereby increases the volume of fuel that can be burned in each cylinder, thus adding an increase in engine horsepower and efficiency for a relatively small addition of weight and volume to the engine. The turbocharger can deliver boost when the engine reaches a high enough RPM to a point, called the boost threshold, that produces sufficient exhaust gas pressure to spin the turbocharger and create pressure at the engine air intake. To control the speed at which the turbine and compressor assembly spins, a mechanical wastegate may be used to keep pressure within the header under a certain threshold.

Turbocharger headers are used to harness the exhaust pressure from the engine cylinder head or heads and transfer the pressure to the turbine. This is the location where a header mounts or bolts to the cylinder head typically using a header flange or cast flange. For a internal combustion engine with multiple cylinders, the exhaust gas header for a turbocharger typically includes duct sections that are each connected to an engine exhaust port and lead to a collection area where the turbine intake to the turbocharger is attached. Exhaust gas flows from the cylinder head through a tube where it collects pressure and velocity, and forces the exhaust through the turbocharger flange or opening where the turbocharger mount fixture and/or flange is attached to the header.

Typically, turbocharger headers are manufactured in such a fashion to provide only the turbocharger to mount in a single, final position. This position is predetermined at the engine manufacturer's design and fabrication stage for each different model of vehicle. In addition to the turbocharger design itself, clearance issues of how to physically fit one or two turbochargers within the limited space around an engine block dominate the design process. Thus, a problem exists with exhaust gas turbocharger header designs because they are built for one particular engine make and model that is installed in a particular vehicle model using a specific manufacturer's cylinder head flange bolt pattern.

### SUMMARY

The present invention, as described in the preferred and alternative embodiments, overcomes the disadvantages and limitations of the prior art by providing a header for an exhaust gas turbocharger with an interior and exterior construction to provide for multiple positions of exhaust gas tubes for intake of gas into the header and for multiple positions of a turbocharger flange that provides an intake channel into a turbocharger turbine. The invention allows a single header, also called a “header log” or “manifold,” design to be used for nearly any type of engine, such as engines in a vehicle where compartment space is limited and formerly only custom turbocharger headers from a vehicle's manufacturer could be installed.

### BRIEF DESCRIPTION OF THE DRAWINGS

For a better understanding of the nature of the present invention, its features and advantages, the subsequent detailed description is presented in connection with accompanying drawings in which:

FIG. 1 illustrates the preferred embodiment arranged for an internal combustion engine;

FIG. 2 illustrates the preferred embodiment installed with a turbocharger on an internal combustion engine;

FIG. 3 is a longitudinal cross-section of the preferred embodiment arranged for an internal combustion engine;

FIG. 4 is a cross-section of the preferred embodiment arranged for an internal combustion engine;

FIG. 5 is a plan view of an alternative embodiment for a header;

FIG. 6 is a cross-sectional view of an alternative embodiment for a header; and

FIG. 7 is a cross-sectional view of an additional alternative embodiment for a header.

### DETAILED DESCRIPTION OF THE INVENTION

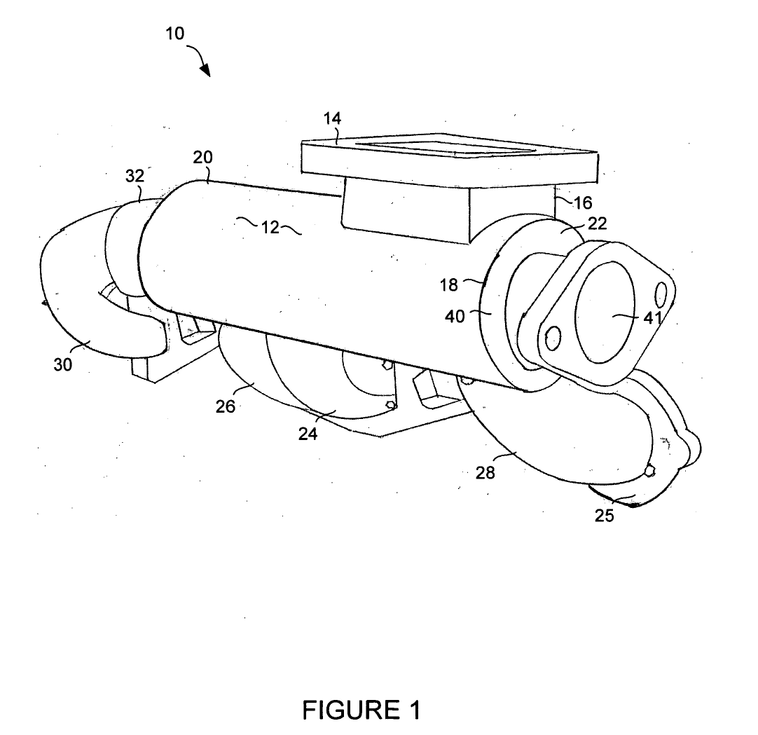

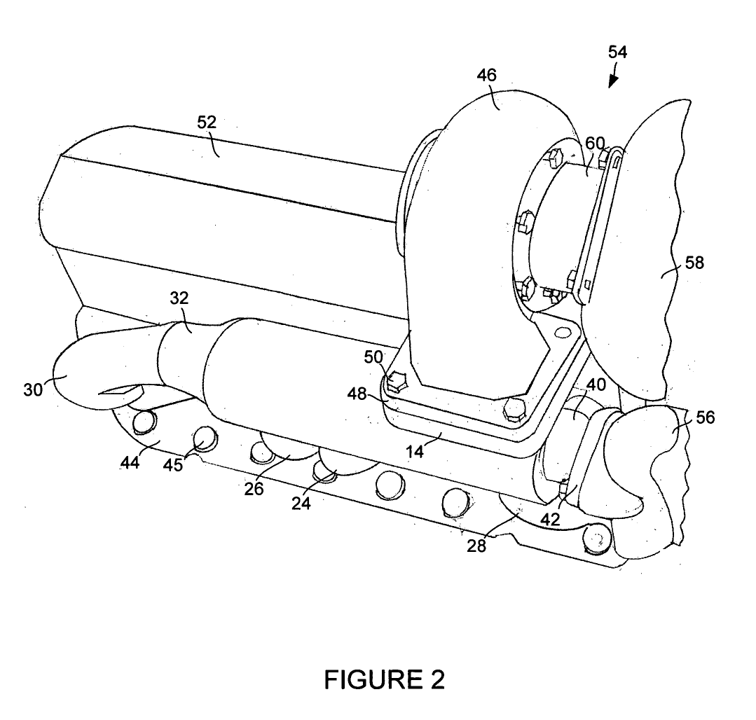

The preferred and alternative embodiments of the present invention provide a header, also called a “header” or “manifold,” for an exhaust gas turbocharger that allows the turbocharger flange, connecting the turbocharger turbine to the header, to be located in any position desired on the longitudinal body of the header. FIG. 1 illustrates an assembly 10 of the header 12 of the preferred embodiment that is prepared for installation on one side of an eight cylinder internal combustion V-8 style engine. FIG. 2 illustrates the assembly of FIG. 1 installed on an engine represented with valve cover 52. As is understood and explained herein, the preferred and alternative embodiments are not limited to use on a specific engine type, size, or arrangement of cylinders on an internal combustion engine. Any engine where a turbocharger is capable of installation thereon can benefit from the present invention, whether or not the engine is used in a vehicle.

Referring again to FIG. 2, header 12 is typically installed longitudinally in parallel with a longitudinal axis of the engine, represented by valve cover 50. The preferred header is constructed with a hollow, cylindrical body 12 as the header having a first flat end 20 (not shown) and a second flat end 22 that sealed or welded to the edges 18 of cylindrical body 12. Exhaust gas tubes may be straight, curved, or angled to multiple degrees of bend. From end 22, exhaust port tubes 24, 26, 28, and 30 are each affixed to a cylinder head, such as the cylinder head 44 illustrated in FIG. 2, by a header flange or casting. Exhaust port tube 24 connects to cylinder head 44 with flange 32, tubes 26 and 28 connect using casting 36, and exhaust port tube 30 connects to cylinder head 44 using casting 38. Tubes 24-28 are attached to the cylindrical body 12 using welds or other attaching methods known in the art. Tube 30 attaches to header end 20 using extension tube 32.

FIG. 2 illustrates portions of a turbocharger assembly 54 that includes turbine 46, connection 56 that houses a shaft, and compressor housing 58 that are connected to header 12. Header 12 is also shown mounted to engine 52, represented partially by cylinder head 44 and engine valve cover 52. Turbine 46 flange 48 are attached using bolts 52 at each corner of the flanges to secure the header assembly 10 to the turbocharger 54. Turbocharger flange 14 is attached to the circumferential wall of header 12 using mounting spacer 16. FIG. 2 further illustrates how flange 14 connects to a similar sized flange 48 at the intake port of turbine 46. The turbocharger flange 14 connection to flange 48 creates a flow channel for gasses from the header to the turbine 46. The exhaust port tubes 24-30 attach at variable locations on the header 12, thereby allowing flange 14 to be mounted and affixed in any location or position longitudinally or vertically onto header 12 relative to the front or side of an engine 52. In this configuration of the preferred embodiment, flange 14 is mounted more towards the back of engine 52.

In FIGS. 1 and 2, a wastegate 56 is depicted as connecting to wastegate flange 42. The external wastegate 56, mounted at an end 22 of header 12 creates boost much more efficiently than affixing a wastegate onto body of header 12 or to a single exhaust port tube 24-30 where some boost or velocity of exhaust gas would travel past the wastegate and into the turbocharger 54. Preferably, wastegate 56 is attached to the end 22 of header 12. Internal header pressure of exhaust gasses will bulkhead towards the end 22 and wastegate 56 thereby creating a more efficient, accurate, and reliable regulation of internal header pressures. Wastegate 56 is an external wastegate for turbocharger 54. Wastegate flange 42 connects the wastegate 56 to header 12 with extension piece 40. An open channel 41 is created through flange 42 and extension 40 into header 12, thereby providing a channel for accumulated exhaust gas in the header 12 to flow into wastegate 56. In an alternative embodiment an external wastegate 56 and flange 42 would not be attached to header 12 if the turbocharger 54 has an internal wastegate or other wastegate design. Thus, while the preferred embodiment provides for a design having a wastegate installed on header 12, the external wastegate 56 would only be used for turbochargers 54 that require an external wastegate design. If external wastegate 56 is installed at end 22 of header 12, it will minimize pressure drops and keep pressure more consistent across all of an engine's cylinders that are connected to header 12 by allowing the cylinders to evenly pressurize the header 12 to which an external wastegate 56 is mounted.

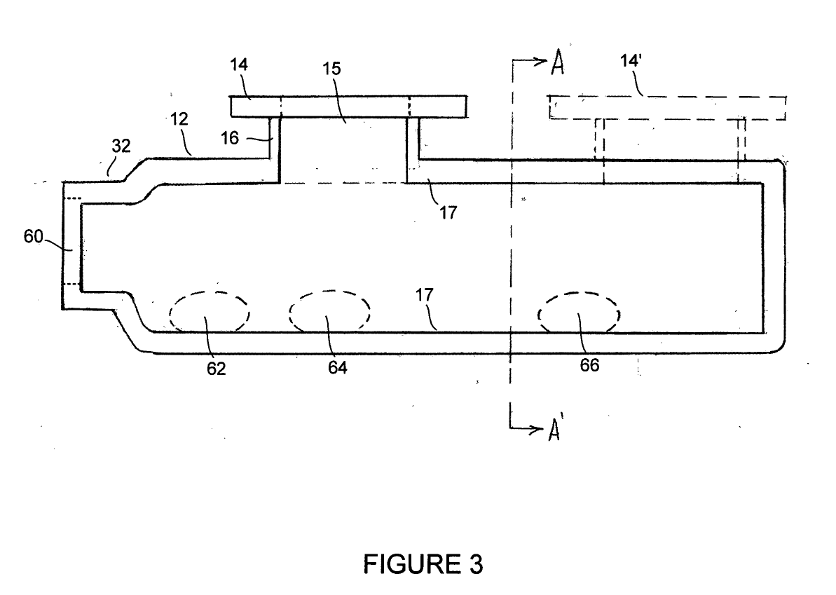

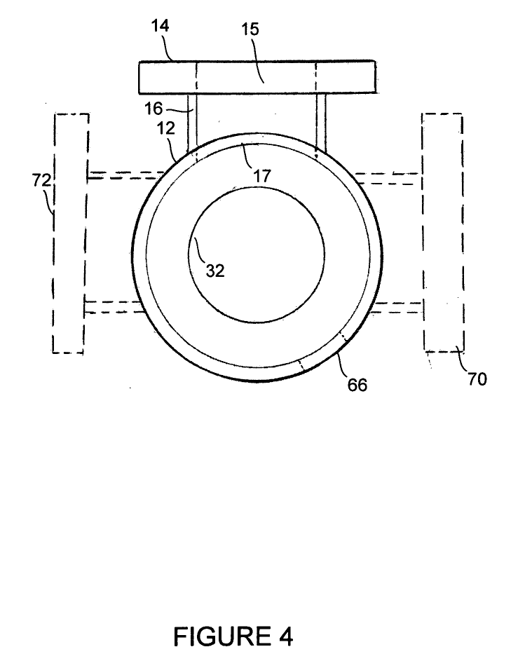

Referring to FIG. 3, a longitudinal cross-section of the preferred header 12 is illustrated. Header 12 is shown without any attaching exhaust gas tubes and without an attached external wastegate. However, exemplary locations for connecting exhaust gas tubes are shown in FIG. 3 as channel openings 66, 64, and 62, on the header 12, and channel opening 60 created through extension 30 on end 20 of header 12. FIG. 4 illustrates a view of cross section A-A′ from FIG. 3, of the preferred header 12. Exhaust channel opening 66 is shown without any attaching exhaust port tube. Further, intake exhaust channel 60, formed by extension 32 on end 20 of header 12, is shown.

Another important aspect of the invention is that turbocharger flange may also be positioned at any feasible location around the outside of body 12. As one skilled in the art would know, the positions depend upon an engine's configuration and, if installed in a vehicle, the space and obstructions within and engine compartment. From the view of FIG. 4, flange 14 is positioned vertically on top of cylindrical body 12. However, this position could be modified to flange position 70, flange position 72 or any angle away from vertical that is possible depending upon the engine location relative to header 12 or other obstructions around the engine.

Header 12 is built with a generally hollow body, such as a cylindrically-shaped body, with an open, generally unobstructed interior gas flow channel 13 created within interior wall 17 for exhaust gas to flow from an engine's exhaust gas ports into the header 12. Exhaust gas will then pass through channel 15 of the turbocharger flange 14 and into an intake for a turbocharger turbine 46. By forming the interior wall 17 with a consistent longitudinal flowpath and by removing obstructions within the inside wall 17 of header body 12, uniformity in header design is created so that exhaust tubes may enter the header from any direction and turbocharger flange 14 may be placed in various positions on the header that are possible in relation to the position of an engine 52 and its components and/or under-the-hood space in a vehicle. For example, FIG. 3 shows that instead of turbocharger flange 14 positioned near exhaust gas channel opening 60, the flange could be moved to a position 14′ without degradation in performance of the turbocharger.

Materials of construction for the preferred and alternative embodiments include stainless or other variations of steel that include types 304 and 321, cast iron or other cast, molded, extruded, and 3-D metals and composite materials including synthetic compounds such as ceramic. The materials of construction should meet appropriate turbocharger specifications and withstand temperatures, pressures, welds, and structural rigidity required for a turbocharger header.

Wall thickness of header 12 depends upon the materials of construction and expected pressures and temperatures of exhaust gasses handled by the header. For example, a high-grade stainless steel header body would need approximately 0.030 to 0.070 inch thick walls, while a cast iron header body would need approximately 0.10 to 0.50 inch thick walls for a header installed on a medium-sized V-8 engine. Length and cross-sectional diameter of the preferred header 12 may also vary according to engine size and space near the engine's cylinder head. With the present embodiments, though, extending or shortening the header and increasing or decreasing the cross-sectional diameter allows the header to fit in nearly any engine compartment yet does not change the basic flexibility of design aspects of the device. For the typical medium-sized V-8 engine, a header may range from approximately 18 to 30 inches in length and 5 to 16 inches in cross-sectional diameter.

Advantages of the preferred turbocharger header design include that flange 14 may be affixed or welded in any number of permissible locations on header 12. The uniform construction of the 12 externally and internally provides for nearly unlimited mounting positions for flange 14 on header 12 enables the turbo header to be installed on a wide variety of engines and vehicle designs. The flexibility of the preferred and alternative designs solves many problems with space and clearance issues that are encountered when installing a turbocharger under the front hood of a vehicle that has relatively small amount of space in the engine compartment. Besides the positions shown in FIGS. 1-4, a user can alternatively weld or mount the turbocharger mountain flanges in varying positions on the header, such as forward or backward relative to the location of the front or back of an engine, and straight up, down, or on the side of the header relative to the position of the header as illustrated in the exemplary views in FIGS. 3 and 4.

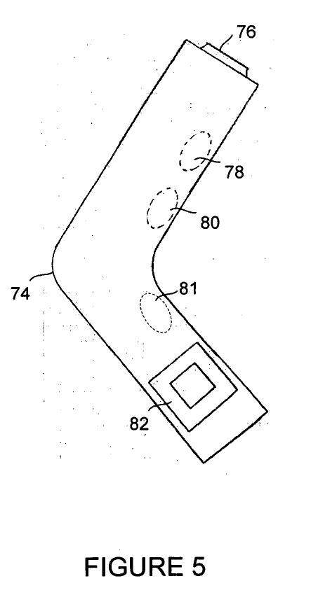

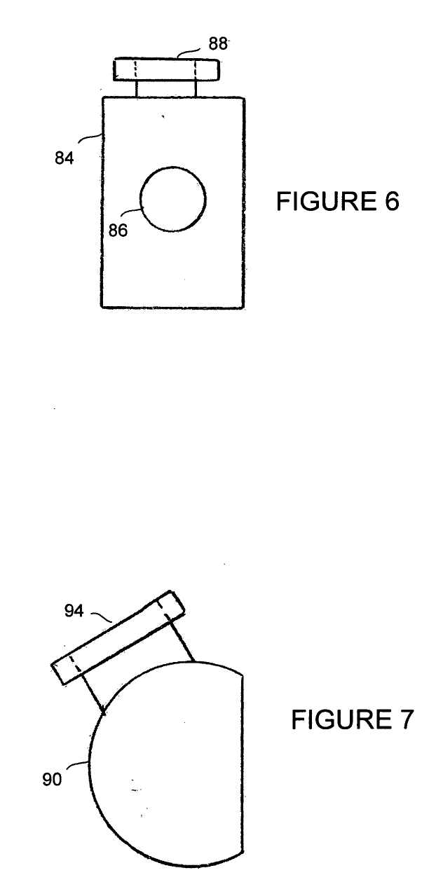

Alternative embodiments for the design shape of header 12 itself are illustrated in the plan view of FIG. 5 and cross-sectional views of FIGS. 6 and 7. FIG. 5 illustrates alternative header 74 having a ell-shaped design. Cylinder exhaust gas intake points 80 and 78 are located on the body of header 74, while exhaust gas intake point 76 is located on an end of the header body. Turbocharger connection flange 82 is located on the end distal from the exhaust gas intake points. The alternative embodiment 74 could have other shapes while maintaining the same features for unobstructed interior walls and materials of construction as described for the preferred embodiment. FIG. 6 represents an exemplary cross-section of an alternative embodiment for a header 84 that is square but could be square, rectangular, pentagonal, or other straight-walled instead of a cylindrical body 12 of FIG. 4. Turbocharger flange 88 is located on a flat edge of body 84 and exhaust gas intake point 86 is positioned at an end of the header 84. FIG. 7 illustrates a further exemplary cross-section of an alternative embodiment for a header 90 having a wedge shaped cross-sectional area. Exhaust gas intake points could be located anywhere feasible on the body design, on the flat ends (not shown) and turbocharger flange 94 is shown on the convex side of the header 90.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

What is claimed:

1. A header for an exhaust gas turbocharger, comprising:
a cylindrical body comprising a first end and a second end that each attach to the circumferential edges of the body and comprising an exhaust gas flow channel formed by an interior wall of the body;
an exhaust gas intake channel opening formed in the body that can connect to an exhaust port tube and receive exhaust gas from a cylinder head of an engine;
a turbocharger flange attached to the body providing an exhaust gas flow channel for exhaust gasses to leave the body,
wherein the interior channel is used as a flowpath for exhaust gasses to pass from the exhaust gas intake channel to the turbocharger flange, such that the turbocharger flange may be placed at any position on the circumferential body surface.

2. The header of claim 1, wherein the exhaust gas flow channel is formed as a single, unobstructed interior channel.

3. The header of claim 2, wherein the exhaust gas flow channel is formed with a uniform circumferential interior surface for the length of the body of the header.

4. The header of claim 1, wherein the flange may be located in any position on the surface of the body without a degradation of the turbocharger performance.

5. The header of claim 1, further comprising:
an exhaust gas tube, connected to the exhaust gas intake channel, for channeling exhaust gasses between an exhaust gas port on a cylinder head of an engine and the body,
wherein the exhaust gas intake channel may be located at any position on the surface of the body that is not occupied by the flange.

6. An internal combustion engine, comprising:
an exhaust gas turbocharger, connected to an air intake for the engine; and
a header, connected to the exhaust gas turbocharger, the header comprising:
a cylindrical body comprising a first end and a second end that each attach to the circumferential edges of the body and comprising an exhaust gas flow channel formed by an interior wall of the body;
an exhaust gas intake channel opening formed in the body that can connect to an exhaust port tube and receive exhaust gas from a cylinder head for the engine;
a turbocharger flange attached to the body providing an exhaust gas flow channel for exhaust gasses to leave the body,
wherein the interior channel is used as a flowpath for exhaust gasses to pass from the exhaust gas intake channel to the turbocharger flange, such that the turbocharger flange may be placed at any position on the circumferential body surface.

7. The engine of claim 6, wherein the exhaust gas flow channel is formed as a single, unobstructed interior channel.

8. The engine of claim 7, wherein the exhaust gas flow channel is formed with a uniform circumferential interior surface for the length of the body of the header.

9. The engine of claim 6, wherein the flange may be located in any position on the surface of the body without a degradation of the turbocharger performance.

10. The engine of claim 6, further comprising:
an exhaust gas tube, connected to the exhaust gas intake channel, for channeling exhaust gasses between an exhaust gas port on a cylinder head of an engine and the body,
wherein the exhaust gas intake channel may be located at any position on the surface of the body that is not occupied by the flange.

11. An exhaust gas turbocharger and header assembly, comprising:
an exhaust gas turbocharger, connected to an air intake for an engine; and
a header, comprising:
a hollow body comprising a first end and a second end forming an sealed internal exhaust gas flow channel formed by an interior wall of the body;
one or more exhaust gas intake channel openings formed in the body that can connect to an exhaust port tube and receive exhaust gas from a cylinder head of the engine; and
a turbocharger flange attached to the body providing an exhaust gas flow channel that connects to the turbocharger,
wherein the interior channel is used as a flowpath for exhaust gasses to pass from the exhaust gas intake channel to the turbocharger flange, such that the turbocharger flange may be placed at any position on the body surface.

12. The assembly of claim 11, wherein the exhaust gas flow channel is formed as a single, unobstructed interior channel.

13. The assembly of claim 12, wherein the exhaust gas flow channel is formed with a uniform interior surface for the length of the body of the header.

14. The assembly of claim 11, wherein the flange may be located in any position on the surface of the body without a degradation of the turbocharger performance.

15. The assembly of claim 11, further comprising:
an exhaust gas tube, connected to the exhaust gas intake channel, for channeling exhaust gasses between an exhaust gas port on a cylinder head of an engine and the body,
wherein the exhaust gas intake channel may be located at any position on the surface of the body that is not occupied by the flange.

16. The assembly of claim 11, wherein the body of the header is cylindrically formed with a uniform interior and exterior, except for the one or more intake channels and flange channel, for the length of the header.

17. The assembly of claim 11, wherein the body of the header is formed with at least one straight wall along the length of the header.
